(19) United States
(12) Patent Application Publication
(10) Pub. No.: US 2019/0249748 A1
(43) Pub. Date: Aug. 15, 2019

(54) Flexible-Drive Overrunning Alternator Pulley

(71) Applicant: ALT AMERICA INC., Westland, MI (US)

(72) Inventors: Wenhuan Wang, Westland, MI (US); Hao Xu, Jiangsu Province (CN)

(21) Appl. No.: 15/895,262

(22) Filed: Feb. 13, 2018

(51) Int. Cl. F16F 15/121; F16H 55/36

(52) U.S. Cl. CPC F16F 15/1216; F16H 2055/366; F16H 55/36

(57) ABSTRACT

A flexible-drive overrunning alternator pulley includes a shaft that includes a flange disposed at a first end of the shaft; an axle extending from a first side of the flange to a second end of the shaft; a shaft sleeve that includes first splines that include one or more teeth; a spring that includes a first end and a second end; and a bearing that includes: an inner bore extending through the bearing; an upper portion of the bearing including second splines that include one or more teeth; a middle portion of the bearing that includes a roller, wherein the roller is adapted to engage the upper portion of the bearing; and a lower portion of the bearing that includes a chamber adapted to receive a portion of the roller of the middle portion.

### TECHNICAL FIELD

This disclosure relates to flexible-drive overrunning alternator pulleys.

### BACKGROUND

Vehicle engines, such as internal combustion engines, typically include an alternator that, when driven by a pulley of the vehicle engine, provides electrical power to components of the vehicle. For example, the alternator may provide electrical power to a battery of the vehicle, which may charge the battery. As the vehicle engine operates, a mechanical load may be transferred to the alternator and pulley, which may be referred to as an alternator-pulley system.

Increasingly, modern vehicles require more electrical power to operate various electrical components of the vehicle. This may result in an increased load being placed on components of the vehicle engine, such as the alternator-pulley system. The increased load placed on the alternator-pulley system may increase an inertia generated by the alternator, which may result in wear or damage to the alternator-pulley system.

In order to reduce the impact on an alternator-pulley system caused by the increased load, the alternator-pulley system may include a one-way overrunning alternator pulley that transmits torque from the vehicle engine to the alternator. A one-way overrunning alternator pulley can reduce negative side effects experienced by the alternator-pulley caused by inertia generated by the alternator. However, while the pulley is driving the alternator, the one-way overrunning alternator pulley may generate irregular vibrations that decrease the operating efficiency of the alternator-pulley system and/or create an undesirable experience for an operator of a vehicle associated with the vehicle engine.

### SUMMARY

Disclosed herein are implementations of flexible-drive overrunning alternator pulleys.

An aspect of the disclosed embodiments is a flexible-drive overrunning alternator pulley for reducing vibration and noise associated with a vehicle engine. The flexible-drive overrunning alternator pulley comprises: a shaft that comprises: a flange disposed at a first end of the shaft; and an axle extending from a first side of the flange to a second end of the shaft, the second end of the shaft being opposed to the first end of the shaft; a shaft sleeve adapted to receive the axle of the shaft; first splines that include one or more teeth being disposed on a first side of the shaft sleeve; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; a pulley that comprises an inner bore extending from a first side of the pulley to a second side of the pulley; and a bearing adapted to engage the first splines, wherein the bearing transmits torque between the pulley and the shaft sleeve in response to the speed of the pulley being higher than the speed of the shaft sleeve, and wherein the bearing overruns in response to the speed of the pulley being lower than the speed of the shaft sleeve.

Another aspect of the disclosed embodiments is a pulley that comprises: a shaft that comprises: a flange disposed at a first end of the shaft; and an axle extending from a first side of the flange to a second end of the shaft, the second end of the shaft being opposed to the first end of the shaft; a shaft sleeve adapted to receive the axle of the shaft; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; and a bearing that includes: an inner bore extending through the bearing; an upper portion of the bearing adapted to engage a portion of the shaft sleeve; a middle portion of the bearing that includes a roller, wherein the roller is adapted to engage a portion of the upper portion of the bearing; and a lower portion of the bearing that includes a chamber adapted to receive a portion of the roller of the middle portion.

Another aspect of the disclosed embodiments is a system that comprises: a shaft that comprises: a flange disposed at a first end of the shaft; and an axle extending from a first side of the flange to a second end of the shaft, the second end of the shaft being opposed to the first end of the shaft; a shaft sleeve adapted to receive the axle of the shaft; first splines that include one or more teeth being disposed on a first side of the shaft sleeve; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; a bearing that includes: an inner bore extending through the bearing; an upper portion of the bearing that includes second splines including one or more teeth being disposed on the inner bore of the bearing, wherein the second splines are adapted to correspond with the first splines being disposed on the shaft sleeve; a middle portion of the bearing that includes a roller, wherein the roller is adapted to engage a portion of the upper portion of the bearing; and a lower portion of the bearing that includes a chamber, wherein the chamber is adapted to receive a portion of the roller of the middle portion; a washer that includes an inner bore adapted to receive a portion of the flange of the shaft; a pulley that includes an inner bore extending through the pulley, wherein the inner bore is adapted to receive the washer and the bearing; and a ball bearing that includes an inner bore that receives a portion of the axle of the shaft, wherein the ball bearing is adapted to be received by the inner bore of the pulley.

Variations in these and other aspects, features, elements, implementations, and embodiments of the methods, apparatus, procedures, and algorithms disclosed herein are described in further detail hereinafter.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 generally illustrates an example of a flexible-drive overrunning alternator pulley assembly according to the principles of the present disclosure.

FIGS. 2A-2B generally illustrate a shaft according to the principles of the present disclosure.

FIGS. 3A-3D generally illustrate a bearing according to the principles of the present disclosure.

FIGS. 4A-4B generally illustrate a pulley including a washer according to the principles of the present disclosure.

FIG. 5 generally illustrates a bearing according to the principles of the present disclosure.

FIG. 6 generally illustrates a shaft sleeve according to the principles of the present disclosure.

FIG. 7 generally illustrates a spring according to the principles of the present disclosure.

FIG. 8 generally illustrates an exploded view of the flexible-drive overrunning alternator pulley of FIG. 1.

### DETAILED DESCRIPTION

A vehicle typically utilizes electrical power in order to control ignition components and/or other electronic components associated with the vehicle. A vehicle engine, such as a spark-ignition internal combustion engine or other suitable engine, includes an alternator-pulley system. As the vehicle engine operates, the vehicle engine drives a belt associated with the alternator-pulley system which drives an alternator of the alternator-pulley system. The alternator provides electrical power to a battery of the vehicle. The electrical power may charge the battery. The battery may be used to supply electrical power ignition components of the vehicle during vehicle startup. The vehicle engine and/or components of the alternator-pulley system may produce undesirable vibration and/or noise while the engine and the alternator-pulley system operate. As the amount of electrical power utilized by a modern vehicle has increased, alternator loads and engine torsional fluctuations have increased proportionally. Accordingly, it may be desirable to utilize an alternator-pulley system that includes higher decoupling capabilities, a higher damping ratio, and greater flexibility than the characteristic of typical alternator-pulley systems, which may reduce vibration and/or noise generated by the alternator-pulley system. This may prolong the life of the alternator-pulley system and/or the vehicle engine, while increasing an efficiency of power transmission from the vehicle engine to the alternator.

In some embodiments according to the principles of the present disclosure, an alternator-pulley system includes a flexible-drive overrunning alternator pulley. A flexible-drive overrunning alternator pulley is adapted to transmit torque from the vehicle engine to the alternator through the flexible-drive overrunning alternator pulley in response to acceleration of the vehicle engine. The flexible-drive overrunning alternator pulley is adapted to decouple the alternator from the pulley when the alternator overruns the pulley (e.g., when an angular velocity of the alternator is higher than an angular velocity of the pulley). As will be described, the flexible-drive overrunning alternator pulley reduces and/or controls vibration and/or noise generated by the vehicle engine and/or the alternator-pulley system. Additionally, or alternatively, the flexible-drive overrunning alternator pulley can reduce and/or control belt jitter, increase power transmission efficiency of a battery charging system associated with the battery, and/or prolong the operating life of components of the alternator-pulley system and/or other components associated with the vehicle engine.

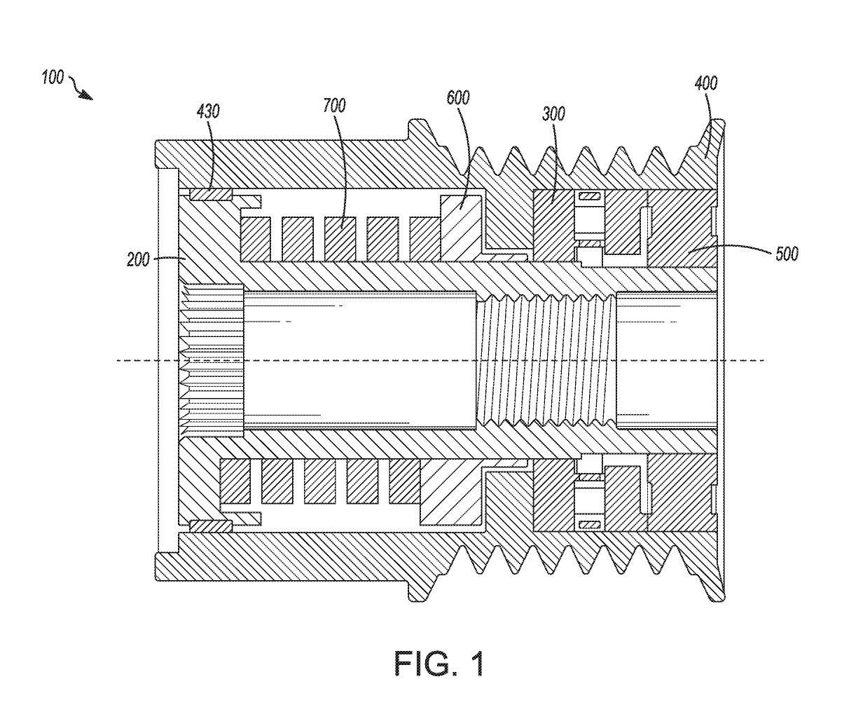

FIG. 1 generally illustrates an example of a flexible-drive overrunning alternator pulley assembly 100 according to the principles of the present disclosure. The flexible-drive overrunning alternator pulley assembly 100 can be associated with a vehicle engine, such as a spark-ignition internal combustion engine or other suitable engine, as described above. The flexible-drive overrunning alternator pulley assembly 100 transmits torque from the engine to the alternator when the engine speed increases, and decouples the engine and the alternator when the engine speed is decreased. Additionally, or alternatively, the flexible-drive overrunning alternator pulley assembly 100 may reduce, inhibit, and/or eliminate vibration and/or noise associated with an alternator-pulley system and/or other components of the vehicle engine.

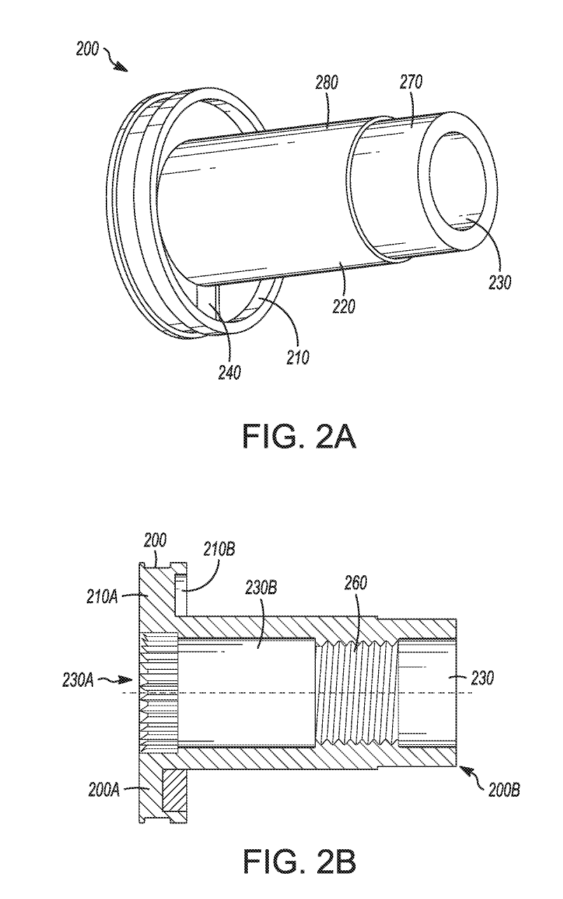

The flexible-drive overrunning alternator pulley assembly 100 includes a shaft 200, a bearing 300, a pulley 400, a washer 430, a bearing 500, a shaft sleeve 600, and a spring 700. As is generally illustrated in FIGS. 2A-2B, the shaft includes a flange 210, an axle 220, an inner bore 230, and a first spring seat aperture 240. The flange 210 is disposed at a first end 200A of the shaft 200. A first side 210A of the flange 210 is disposed on the opposite side of the second side 210B of the flange 210. The axle 220 extends from a first side 210A of the flange 210 to a second end 200B of the shaft 200. The first end 200A of the shaft 200 is disposed on an opposite side of the shaft 200 from the second end 200B of the shaft 200. The inner bore 230 extends from a central or substantially central portion of the first end 200A of the shaft 200 to the second end 200B of the shaft 200. The inner bore 230 includes a first inner portion 230A and a second inner portion 230B. The first inner portion 230A includes a surface that includes a cylindrical or substantially cylindrical profile. The second inner portion 230B includes a surface that includes a cylindrical or substantially cylindrical profile. The profile of the first inner portion 230A has a diameter that is larger than a diameter of the profile of the second inner portion 230B.

The first spring seat aperture 240 is disposed at the second side 210B of the flange 210. For example, the second side 210B of the flange 210 includes a recess that includes an arcuate or substantially arcuate profile, or other suitable profile. The first spring seat aperture 240 is disposed on an end of the recess.

In some embodiments, the axle 220 includes a first outer portion 270 and a second outer portion 280. The first outer portion 270 includes a cylindrical or substantially cylindrical profile, or other suitable profile. The second outer portion 280 includes a cylindrical or substantially cylindrical profile, or other suitable profile. A diameter associated with the profile of the first outer portion 270 is smaller than a diameter associated with the profile of the second outer portion 280.

The shaft 200 includes one or more splines 250 disposed on the surface of the first inner portion 230A. The splines 250 can be straight-sided splines, involute splines, other suitable splines, or a combination thereof. The shaft 200 includes threads 260 disposed on the surface of the second inner portion 230B. The threads 260 may include helical threads or other suitable threads. The threads 260 may be left-handed threads, right-handed threads, or other suitable threads.

In some embodiments, the shaft 200 may be adapted to cooperatively operate with a portion of the alternator to transmit torque to the alternator. For example, the shaft 200 may engage a portion of the alternator at the threads 260 and/or splines 250. For example, the alternator may include a shaft that includes threads that are adapted to mate or cooperate with the threads 260. The threads associated with the alternator shaft may have the same or similar pitch, hand, and nominal diameter as the threads 260. The alternator shaft may engage (e.g., may be screwed into) the inner bore 230 of the shaft 200.

Additionally, or alternatively, the alternator shaft may include splines that correspond to the splines 250 of the shaft 200. The alternator shaft may be adapted to engage the shaft 200 by mating the splines of the alternator shaft with the splines 250 of the shaft 200. Engagement of the alternator shaft and the shaft 200 can be adjusted by a wrench or another suitable device. As described herein, the diameter of the first inner portion 230A is larger than the diameter associated with the second inner portion 230B. An outer diameter of the alternator shaft may include a diameter that is slightly smaller than the diameter of the first inner portion 230A and slightly larger than the diameter of the second inner portion 230B, such that the alternator shaft cannot pass into or through the inner bore 230.

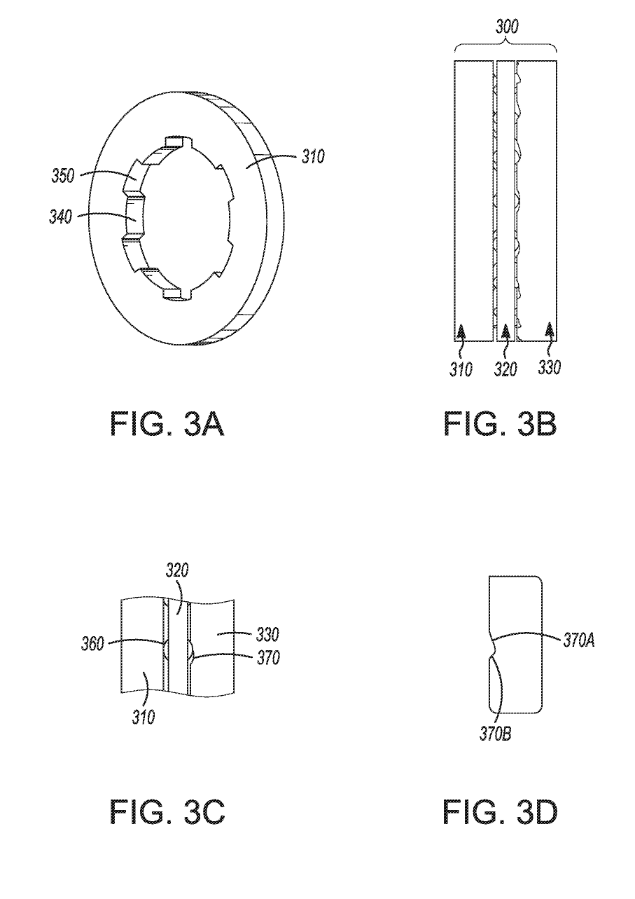

The flexible-drive overrunning alternator pulley assembly 100 includes a bearing 300, as is generally illustrated in FIGS. 3A-3D. The bearing 300 includes an upper portion 310, a middle portion 320, a lower portion 330, and an inner bore 340. The inner bore 340 extends from the upper portion 310 to the lower portion 330. The middle portion 320 includes one or more rollers 360. The lower portion 330 includes a chamber 370 disposed on a first side of the lower portion 330. The one or more rollers 360 are adapted to engage a first side of the upper portion 310. The chamber 370 is adapted to receive a portion of the one or more rollers 360. The one or more rollers 360 may include cylinders, spheres, or other suitable rollers.

In some embodiments, the chamber 370 includes an asymmetric wedge-shaped profile or other suitable profile. For example, the profile of the chamber 370 includes two surfaces that are defined by a lower ramp 370B and an upper ramp 370A. The slope of a profile of the lower ramp 370B is steeper than the slope of a profile of the upper ramp 370A. For example, the slope of the profile of the upper ramp 370A may be adapted, such that the rollers 360 ride or traverse a portion of the upper ramp 370A and lock or jam the upper portion 310 and/or the lower portion 330 when the one or more rollers 360 are driven by the chamber 370 in a first direction. The slope of the profile of the lower ramp 370B may be adapted to stop the rollers 360 from riding or traversing a portion of the lower ramp 370B when the rollers 360 are driven by the chamber 370 in a second direction that is opposite to the first direction (e.g., the rollers 360 roll between the upper portion 310 and the lower portion 330).

In some embodiments, the upper portion 310 includes splines 350 that define the inner profile of the upper portion 310. For example, the splines 350 include one or more teeth that include a profile. The profile of the splines 350 may include a square or substantially square profile, a round or substantially round profile, or other suitable profile. In some embodiments, the one or more teeth of the splines 350 are evenly or substantially evenly distributed around the inner profile of the inner bore 340. While only limited examples are described herein, the splines 350 may be implemented in various ways, such as a non-spline key set.

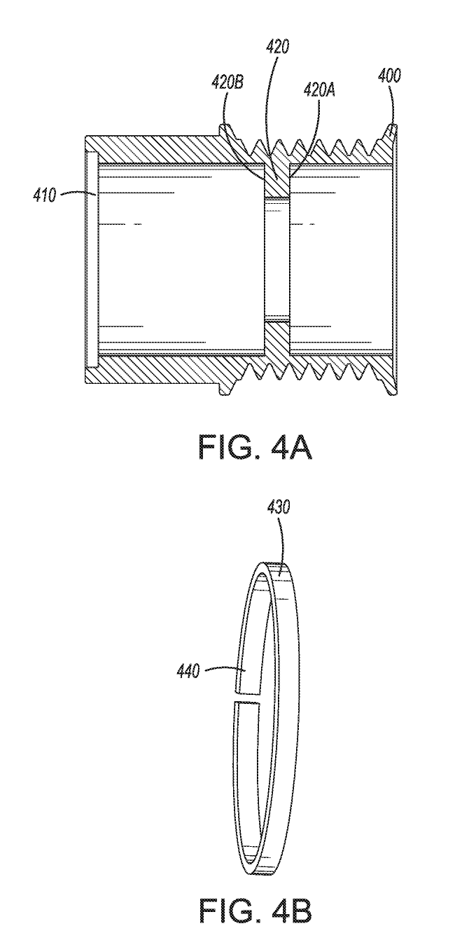

In some embodiments, the flexible-drive overrunning alternator pulley assembly 100 includes a pulley 400, as is generally illustrated in FIGS. 4A-4B. The pulley 400 includes an inner bore 410 and a stopper 420. The stopper 420 includes a first portion 420A disposed on a first side of the stopper 420 and a second portion 420B disposed on a second side of the stopper 420, opposite the first side of the stopper 420. The stopper 420 includes a profile having a diameter that is smaller than a diameter of the inner bore 410. The first portion 420A includes a profile to prevent the shaft sleeve 600 from passing through the inner bore 410. The second portion 420B includes a profile adapted to prevent the bearing 300 from passing through the inner bore 410. The first portion 420A is adapted to engage a portion of the upper portion 310 of the bearing 300. For example, the diameter associated with the first portion 420A is smaller than the diameter of the outer profile of the upper portion 310, such that the upper portion 310 prevents the bearing 300 from passing through the inner bore 410.

In some embodiments, the pulley 400 includes a washer 430. The outer profile of the washer 430 is defined by the inner profile of the inner bore 410. The washer 430 is adapted to be received by the inner bore 410. For example, the washer 430 is press-fit into the inner bore 410. The washer 430 may be adapted to slide into the inner bore 410. In some embodiments, the washer 430 includes an inner bore 440 that is adapted to receive a portion of the flange 210. For example, the flange 210 is press-fit into the inner bore 440. The washer 430 is adapted to rotate about the flange 210.

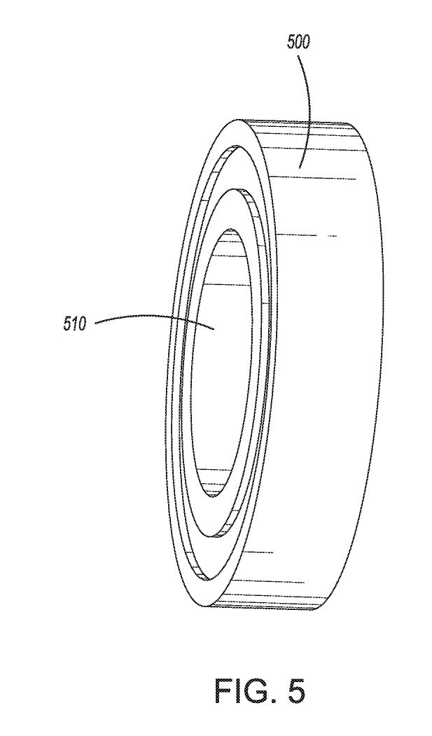

In some embodiments, the flexible-drive overrunning alternator pulley assembly 100 includes a bearing 500, as is generally illustrated in FIG. 5. The bearing 500 can be a ball bearing or other suitable bearing. The bearing 500 includes an inner bore 510 that is adapted to receive a portion of the axle 220. In some embodiments, the bearing 500 is disposed at a second side of the lower portion 330 of the bearing 300, opposite the first side. The bearing 500 is adapted to rotate about the axle 220. For example, the inner profile of the inner bore 510 includes a profile that corresponds to a profile of the first outer portion 270 of the axle 220. The axle 220 is press-fit into the bearing 500, such that the first outer portion 270 is received by the inner bore 510. The bearing 500 is adapted to be received by the inner bore 410 of the pulley 400. The outer profile of the bearing 500 is adapted to correspond to a profile of the inner bore 410. For example, the bearing 500 can be press-fit into the inner bore 410 of the pulley 400.

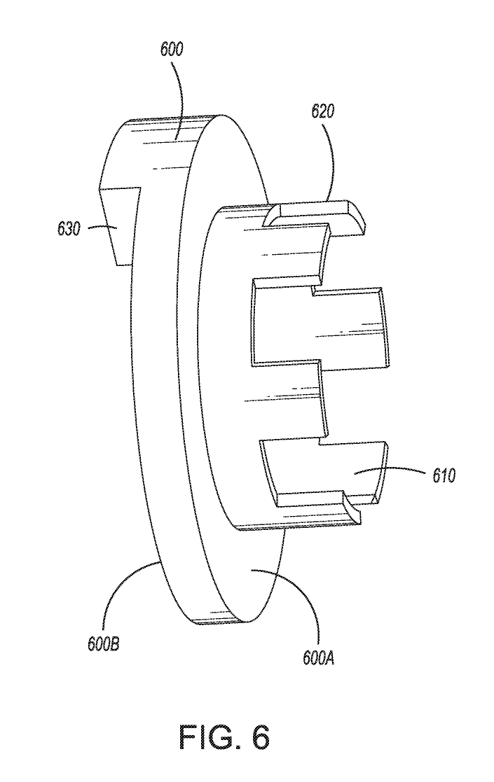

The flexible-drive overrunning alternator pulley assembly 100 includes a shaft sleeve 600, as is generally illustrated in FIG. 6. The shaft sleeve 600 includes an axle 610, splines 620, an inner bore 630, and a second spring seat aperture 640. The axle 610 extends through a central or substantially central portion of the shaft sleeve 600 from a first side 600A of the shaft sleeve 600. The inner bore 630 extends through the shaft sleeve 600. The splines 620 include one or more teeth that are disposed on the first end of the axle 610. For example, the splines 620 include a profile. The profile of the splines 620 may include a substantially square profile, a substantially round profile, or other suitable profile. It should be noted that the splines 620 can also be implemented in various ways, such as a non-spline key set. In some embodiments, the one or more teeth of the splines 620 are evenly or substantially evenly disposed around the axle 610. The splines 620 are adapted to engage or mate with the splines 350. In some embodiments, the first side 600A of the shaft sleeve 600 is adapted to engage the second portion 420B. For example, the second portion 420B includes a profile having a diameter that is smaller than a diameter of the outer profile of the shaft sleeve 600, such that the shaft sleeve 600 prevents the shaft sleeve from passing through the inner bore 410.

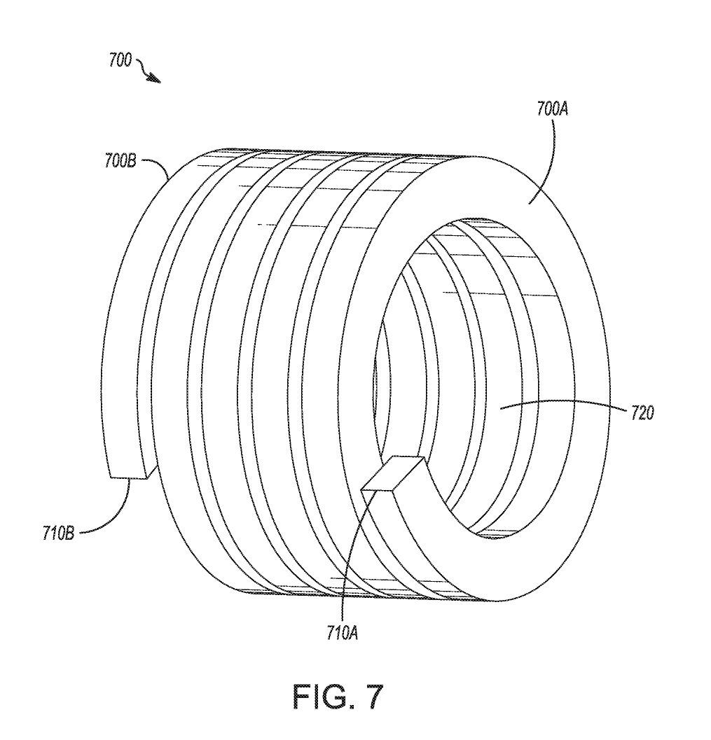

The flexible-drive overrunning alternator pulley assembly 100 includes a spring 700, as is generally illustrated in FIG. 7. The spring 700 includes an inner bore 720. A first side 700A of the spring 700 is adapted to engage the second side 600B of the shaft sleeve 600. For example, a first end 710A of the spring 700 is inserted into a second spring seat aperture 640 disposed on the second side 600B of the shaft sleeve 600. A second side 700B of the spring 700 is adapted to engage the second side 210B of the flange 210. For example, a second end 710B of the spring 700 is inserted into the first spring seat aperture 240 disposed on the second side 210B of the flange 210. The inner bore 720 is adapted to receive the axle 220 at the second outer portion 280. For example, the axle 220 can be press-fit into the inner bore 720. The spring 700 is adapted to transmit torque from the shaft sleeve 600 to the flange 210 when the shaft sleeve 600 runs faster than the flange 210 (e.g., when the angular velocity of the shaft sleeve is higher than the angular velocity of the flange 210). For example, the spring 700 can be a torsional spring coiled counter-clockwise around the axle 220 or other suitable springs. When the shaft sleeve 600 runs faster than the flange 210 in a counter-clockwise direction, the shaft sleeve 600 acts on the spring 700 in a counter-clockwise direction and transmits angular energy to the spring 700. The spring 700 stores a portion of the energy including angular energy and energy that causes irregular vibrations of the components within the alternator-pulley system by coiling up the spring 700. Then the spring 700 releases a portion of the angular energy to the flange 210 and acts on the flange 210 to transmit torque from the shaft sleeve 600 to the shaft 200. The spring 700's resistance to the rotational force may reduce irregular vibrations generated during the torque transition process.

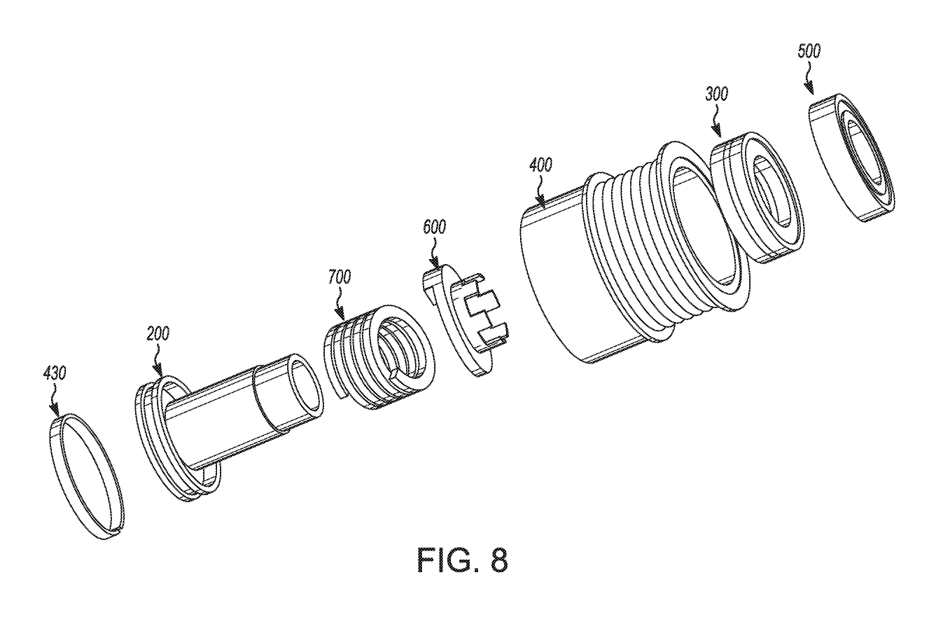

FIG. 8 generally illustrates an exploded view of the flexible-drive overrunning alternator pulley assembly 100 that includes the washer 430, the shaft 200, the spring 700, the shaft sleeve 600, the pulley 400, the bearing 300, and the bearing 500. As described above, the inner bore 410 of the pulley 400 is adapted to receive the shaft 200, the shaft sleeve 600, the spring 700, the bearing 300, and the bearing 500. For example, the bearing 300 and the bearing 500 are inserted into a first side of the pulley 400. The lower portion 330 of the bearing 300 engages a portion of the bearing 500. The spring 700 is slid onto the axle 220 of the shaft 200. The spring 700 is engaged with the flange 210 and the shaft sleeve 600. Additionally, or alternatively, the shaft 200 is inserted into a second side of the bearing 500. The shaft 200 engages the inner bore 410 of the pulley 400 through the washer 430 (e.g., the washer 430 is adapted to receive the round edge of the flange 210 and is adapted to be received by the inner bore 410 of the pulley 400). The shaft sleeve 600 engages a portion of the upper portion 310 of the bearing 300.

In some embodiments, the axle 220 of the shaft 200 is inserted through the inner bore 340 of the bearing 300. As described above, the second outer portion 280 of the axle 220 is adapted to engage the inner bore 340 of the upper portion 310 of the bearing 300 and the inner bore 630 of the shaft sleeve 600. The splines 620 are adapted to engage the upper portion 310 of the bearing 300 at the splines 350, such that the one or more teeth of the splines 620 fit snugly within the one or more teeth of the splines 350. In some embodiments, the surface of the first outer portion 270 includes a diameter that is smaller than the diameter of the inner bore 340 of the bearing 300, such that the bearing 300 only engages the axle 220 by the upper portion 310. The bearing 300 is adapted to rotate about the axle 220 of the shaft 200.

In some embodiments, the round edge profile of the lower portion 330 includes a diameter that is larger than a diameter of the round edge profile of the middle portion 320. The diameter of the round edge profile of the lower portion 330 is also larger than a diameter associated with the round edge profile of the upper portion 310. The round edge profile of the lower portion 330 is adapted to correspond with the inner surface of the inner bore 410. For example, the lower portion 330 is press-fit into the inner bore 410, and the upper portion 310 can rotate within the inner bore 410 when the upper portion 310 is not engaged with the lower portion 330.

In some embodiments, the bearing 300 is adapted to transmit torque from the pulley 400 to the shaft sleeve 600 when the pulley 400 runs faster (e.g., when the angular velocity of the pulley 400 is higher than the angular velocity of the shaft sleeve 600) than the shaft sleeve 600. The bearing 300 is adapted to decouple the pulley 400 and the shaft sleeve 600 when the shaft sleeve 600 overruns the pulley 400 (e.g., when an angular velocity of the shaft sleeve 600 is higher than an angular velocity of the pulley 400). For example, the upper portion 310 of the bearing 300 may engage the shaft sleeve 600, and the lower portion 330 of the bearing 300 may engage the inner bore 410 of the pulley 400.

When the load on the pulley 400 increases, the pulley 400 accelerates in a first direction. The lower portion 330 of the bearing 300 accelerates with the pulley 400 in a first direction. When an angular velocity of the lower portion 330 exceeds an angular velocity of the upper portion 310, the rollers 360 ride up the upper ramp 370A and lock and/or jam the upper portion 310 and the lower portion 330 (e.g., the upper portion 310 and the lower portion 330 are engaged through the rollers 360 and are running at the same speed and in the same direction). The bearing 300 transmits torque from the pulley 400 to the shaft sleeve 600 through the engagement of the shaft sleeve 600 and the upper portion 310. The shaft sleeve 600 then acts on the spring 700, which drives the shaft 200 to accelerate in a first direction. While the pulley 400 is driving the shaft 200, the damping characteristic of the spring 700 reduces and/or controls the vibration and noise generated by the vehicle engine and/or the alternator-pulley system, as described herein.

When the load on the pulley 400 decreases, the pulley 400 decelerates in the first direction. The lower portion 330 of the bearing 300 decelerates with the pulley 400 in the first direction. When the angular velocity of the lower portion 330 is lower than the angular velocity of the upper portion 310, the lower ramp 370B stops the rollers 360 from riding up the lower ramp 370B. The rollers 360 roll between the lower ramp 370B and the upper ramp 370A. The middle portion 320 decouples the upper portion 310 and the lower portion 330 (e.g., the upper portion 310 slides on the lower portion 330 through the rolling of the rollers 360).

In some embodiments, an overrunning alternator pulley for reducing vibration and noise associated with a vehicle engine may include: a shaft that comprises: a flange disposed at a first end of the shaft; and an axle extending from a first side of the flange to a second end of the shaft, the second end of the shaft being opposed to the first end of the shaft; a shaft sleeve adapted to receive the axle of the shaft; first splines that include one or more teeth being disposed on a first side of the shaft sleeve; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; a pulley that comprises an inner bore extending from a first side of the pulley to a second side of the pulley; and a bearing adapted to engage the first splines, wherein the bearing transmits torque between the pulley and the shaft sleeve in response to the speed of the pulley being higher than the speed of the shaft sleeve, and wherein the bearing overruns in response to the speed of the pulley being lower than the speed of the shaft sleeve.

In some embodiments, a pulley may include: a shaft that comprises: a flange disposed at a first end of the shaft; and an axle extending from a first side of the flange to a second end of the shaft, the second end of the shaft being opposed to the first end of the shaft; a shaft sleeve adapted to receive the axle of the shaft; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; and a bearing includes: an inner bore extending through the bearing; an upper portion of the bearing adapted to engage a portion of the shaft sleeve; a middle portion of the bearing that includes a roller, wherein the roller is adapted to engage a portion of the upper portion of the bearing; and a lower portion of the bearing that includes a chamber adapted to receive a portion of the roller of the middle portion.

In some embodiments, a system for reducing vibration and noise associated with a vehicle engine may include: a flange disposed at a first end of the shaft; and an axle extending from a first side of the flange to a second end of the shaft, the second end of the shaft being opposed to the first end of the shaft; a shaft sleeve adapted to receive the axle of the shaft; first splines that include one or more teeth being disposed on a first side of the shaft sleeve; a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; a bearing including: an inner bore extending through the bearing; an upper portion of the bearing that includes second splines including one or more teeth being disposed on the inner bore of the bearing, wherein the second splines are adapted to correspond with the first splines being disposed on the shaft sleeve; a middle portion of the bearing that includes a roller, wherein the roller is adapted to engage a portion of the upper portion of the bearing; and a lower portion of the bearing that includes a chamber, wherein the chamber is adapted to receive a portion of the roller; a washer that includes an inner bore adapted to receive a portion of the flange of the shaft; a pulley that includes an inner bore extending through the pulley, wherein the inner bore is adapted to receive the washer and the bearing; and a ball bearing that includes an inner bore that receives a portion of the axle, wherein the ball bearing is adapted to be received by the inner bore of the pulley.

As used herein, the term “or” is intended to mean an inclusive “or” rather than an exclusive “or”. That is, unless specified otherwise, or clearly indicated otherwise by the context, “X includes A or B” is intended to indicate any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clearly indicated otherwise by the context to be directed to a singular form.

Further, for simplicity of explanation, although the figures and descriptions herein may include components or elements of the system disclosed herein, components or elements of the system disclosed herein may occur in various relative position. Additionally, elements of the system disclosed herein may combine with other elements not explicitly presented and described herein. Furthermore, not all elements of the system described herein may be required to implement a system in accordance with this disclosure. Although aspects, features, and elements are described herein in particular combinations, each aspect, feature, or element may be used independently or in various combinations with or without other aspects, features, and elements.

While the disclosure has been described in connection with certain embodiments or implementations, it is to be understood that the disclosure is not to be limited to the disclosed embodiments or implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An overrunning alternator pulley associated with a vehicle engine, comprising:
a shaft that comprises:
a flange disposed at a first end of the shaft; and
an axle extending from a first side of the flange to a second end of the shaft, the second end of the shaft being opposed to the first end of the shaft;
a shaft sleeve adapted to receive the axle;
first splines that include one or more teeth being disposed on a first side of the shaft sleeve;
a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange;
a pulley that comprises an inner bore extending from a first side of the pulley to a second side of the pulley; and
a bearing adapted to engage the first splines, wherein the bearing transmits torque between the pulley and the shaft sleeve when a speed of the pulley is higher than a speed of the shaft sleeve, and wherein the bearing overruns when the speed of the pulley is lower than the speed of the shaft sleeve.

2. The overrunning alternator pulley of claim 1, wherein the bearing includes:
an inner bore extending through the bearing;
an upper portion of the bearing having second splines that include one or more teeth being disposed on the inner bore of the upper portion of the bearing, wherein the second splines are adapted to correspond with the first splines;
a middle portion of the bearing that includes a roller, wherein the roller is adapted to engage a portion of the upper portion of the bearing; and
a lower portion of the bearing that includes a chamber adapted to receive a portion of the roller.

3. The overrunning alternator pulley of claim 2, wherein the chamber of the lower portion of the bearing includes an asymmetric wedge-shaped profile, wherein the roller jams the lower portion and the upper portion of the bearing when a speed of the lower portion is higher than a speed of the upper portion, and the roller rolls between the lower portion and the upper portion when the speed of the lower portion is lower than the speed of the upper portion.

4. The overrunning alternator pulley of claim 2, wherein the inner bore of the pulley comprises a first stopper and a second stopper, wherein the first stopper is adapted to engage a portion of the upper portion of the bearing and the second stopper is adapted to engage a portion of the shaft sleeve.

5. The overrunning alternator pulley of claim 1, wherein the first end of the spring is received by a first spring seat aperture disposed on the second side of the shaft sleeve and the second end of the spring is received by a second spring seat aperture disposed on the first side of the flange.

6. The overrunning alternator pulley of claim 1, wherein the inner bore of the pulley is adapted to receive the bearing and the shaft sleeve.

7. The overrunning alternator pulley of claim 1, further comprising a ball bearing that comprises an inner bore extending through the ball bearing that receives a portion of the axle, wherein the ball bearing is adapted to be received by the inner bore of the pulley.

8. The overrunning alternator pulley of claim 1, wherein the shaft comprises an inner bore extending from the first end of the shaft to the second end of the shaft, the inner bore having splines disposed proximate to the first end of the shaft.

9. The overrunning alternator pulley of claim 8, wherein the inner bore of the shaft comprises helical threads disposed around an inner portion of the shaft proximate to the second end of the shaft.

10. A pulley comprising:
a shaft that includes:
a flange disposed at a first end of the shaft; and
an axle extending from a first side of the flange to a second end of the shaft, the second end of the shaft being opposed to the first end of the shaft;
a shaft sleeve adapted to receive the axle;
a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange; and
a bearing that includes:
an inner bore extending through the bearing;
an upper portion of the bearing adapted to engage a portion of the shaft sleeve;
a middle portion of the bearing that includes a roller, wherein the roller is adapted to engage a portion of the upper portion of the bearing; and
a lower portion of the bearing that includes a chamber adapted to receive a portion of the roller of the middle portion.

11. The pulley of claim 10, wherein the shaft sleeve includes first splines that include one or more teeth being disposed on the first side of the shaft sleeve.

12. The pulley of claim 11, wherein the upper portion of the bearing includes second splines that include one or more teeth being disposed on the inner bore of the upper portion of the bearing, wherein the second splines are adapted to correspond with the first splines.

13. The pulley of claim 10, wherein the chamber of the lower portion of the bearing includes an asymmetric wedge-shaped profile, wherein the roller jams the lower portion and the upper portion of the bearing when a relative rotation of the lower portion and the upper portion is in a first direction, and the roller rolls between the lower portion and the upper portion when the relative rotation of the lower portion and the upper portion is in a second direction, opposite to the first direction.

14. The pulley of claim 10, wherein the first end of the spring is received by a first spring seat aperture disposed on the second side of the shaft sleeve and the second end of the spring is received by a second spring seat aperture disposed on the first side of the flange.

15. The pulley of claim 14, further comprising an inner bore extending through the pulley, wherein the inner bore is adapted to receive the bearing and the shaft sleeve.

16. The pulley of claim 15, wherein the inner bore of the pulley comprises a first stopper and a second stopper, wherein the first stopper is adapted to engage a portion of the upper portion of the bearing and the second stopper is adapted to engage a portion of the shaft sleeve.

17. A system for reducing vibration and noise associated with a vehicle engine, comprising:
a shaft that includes:
a flange disposed at a first end of the shaft; and
an axle extending from a first side of the flange to a second end of the shaft, the second end of the shaft being opposed to the first end of the shaft;
a shaft sleeve adapted to receive the axle of the shaft;
first splines that include one or more teeth being disposed on a first side of the shaft sleeve;
a spring adapted to engage the first side of the flange at a first end of the spring and a second side of the shaft sleeve at a second end of the spring, wherein the second side of the shaft sleeve is disposed opposite the first side of the shaft sleeve, wherein the spring is adapted to transmit torque between the shaft sleeve and the flange;
a bearing that includes:
an inner bore extending through the bearing;
an upper portion of the bearing that includes second splines that include one or more teeth being disposed on the inner bore of the bearing, wherein the second splines are adapted to correspond with the first splines being disposed on the shaft sleeve;
a middle portion of the bearing that includes a roller, wherein the roller is adapted to engage a portion of the upper portion of the bearing; and
a lower portion of the bearing that includes a chamber, wherein the chamber is adapted to receive a portion of the roller;
a washer that includes an inner bore adapted to receive a portion of the flange;
a pulley that includes an inner bore extending through the pulley, wherein the inner bore is adapted to receive the washer and the bearing; and
a ball bearing that includes an inner bore that receives a portion of the axle, wherein the ball bearing is adapted to be received by the inner bore of the pulley.

18. The system of claim 17, wherein the shaft includes an inner bore extending from the first end of the shaft to the second end of the shaft, wherein the inner bore comprises splines disposed proximate to the first end of the shaft and helical threads disposed proximate to the second end of the shaft.

19. The system of claim 17, wherein the inner bore of the pulley comprises a first stopper and a second stopper, wherein the first stopper is adapted to engage a portion of the upper portion of the bearing and the second stopper is adapted to engage a portion of the shaft sleeve.

20. The system of claim 17, wherein the chamber of the lower portion of the bearing includes an asymmetric wedge-shaped profile, wherein the roller jams the lower portion and the upper portion of the bearing in response to a speed of the lower portion being higher than a speed of the upper portion, and the roller rolls between the lower portion and the upper portion in response to the speed of the lower portion being lower than the speed of the middle portion.
